(19) United States
(12) Patent Application Publication
(10) Pub. No.: US 2008/0182071 A1
(43) Pub. Date: Jul. 31, 2008

(54) Dual purpose mat

(75) Inventor: Chien-chuan Cheng, Taipei City (TW)

Correspondence Address: BACON & THOMAS, PLLC, 625 SLATERS LANE, FOURTH FLOOR, ALEXANDRIA, VA, 22314, US

(73) Assignee: Nitring Enterprise Inc., Taipei City (TW)

(21) Appl. No.: 11/699,380

(22) Filed: Jan. 30, 2007

(51) Int. Cl. B32B 3/10

(52) U.S. Cl. 428/138

(57) ABSTRACT

A dual purpose mat, it can be switched to get an effect of ventilation or heating, and is provided with a control unit for the user to switch and adjust the effects of ventilation and heating. It is applicable to normal mats such as chair cushions, sleeping mats, foot mats etc. to get a function of making warm in winter and cool in summer. The present invention can be designed to be soft, light, thin and portable, and can be collapsed for storing.

### BACKGROUND OF THE INVENTION

1. Field of the Invention

The present invention relates to a dual purpose mat, and especially to the technique of a dual purpose mat applicable to normal mats such as chair cushions, sleeping mats, foot mats etc., it can be switched according to the demand of a user to get an effect of ventilation or heating, thereby it can have the function of making warm in winter and cool in summer.

2. Description of the Prior Art

A conventional dual purpose mat suitable for warming an cooling for seating or lying of a user is provided in one side of the mat with heat keeping material, and in the other side with material that feels cool or is ventilative to get the function of making warm in winter and cool in summer. For example: the mat is provided in its one side with a warm keeping layer made from thicker and softer cotton cloth or flannelette, in order that the user can keep his temperature to be not subjected to lowering when he seat or lie in wintertime; and the mat is provided in its other side with an air ventilative layer made by knitting with bamboo or dry grasses, in order that the user can feel cool when he seats or lies in summertime.

Although a conventional dual purpose mat costs low, the mat itself does not have the function of automatically heating or ventilating, and hence generally it can not satisfy the expectation and need of a user in chilly wintertime or hot summertime.

### SUMMARY OF THE INVENTION

The primary object of the present invention is to provide a dual purpose mat having the function of automatically heating or ventilating and allowing a user to switch according to his demand to get an effect of ventilation or heating. The dual purpose mat at least comprises a separating layer, a ventilative layer, an air vent layer, a fan, a heating unit, a control unit for the user to switch and adjust by controlling the fan and the heating unit; when the fan is operated, the air vent layer can have an effect of ventilation; and when the heating unit emits heat, the temperature of the dual purpose mat can be increased.

In practicing, the functions of heating and ventilating generated by the dual purpose mat can, in addition to being acting on the upper surface of the dual purpose mat to present a single-side-operating embodiment, also present a two-side-operating embodiment acting on the upper and the lower surfaces of the dual purpose mat.

When the dual purpose mat presents a single-side-operating embodiment, the structure of the mat can have both the automatically heating and ventilating functions without turning the mat upside down. The single-side-operating mode of the dual purpose mat comprises structurally a separating layer; a ventilative layer neighboring with the separating layer, a side of the ventilative layer neighboring with the separating layer is provided at least with a first spacing means forming a first ventilation space, the ventilative layer is provided in corresponding to the first ventilation space with a lot of ventilative holes extending through to the other side of the mat; an air vent layer provided neighboring with the ventilative layer; a fan in communication with the first ventilation space to absorb outside air in or blow out air from the first ventilation space; a heating unit provided between the separating layer and the air vent layer (for example: the heating unit can be provided between the ventilative layer and the separating layer), and a control unit connected with the fan and the heating unit.

When it is desired to develop the ventilating function of the dual purpose mat, a user can manipulate the control unit to activate operation of the fan, and the fan can absorb air from outside into the first ventilation space, and can blow out the air to endue the air vent layer with the effect of ventilating and heat scattering.

When it is desired to develop the warm keeping function of the dual purpose mat, the user can manipulate the control unit to activate operation of the heating unit, and the heating unit can increase the entire temperature of the dual purpose mat by the heat it generates to thereby provide a suitable effect of keeping out the cold for the user, alternatively, the heating unit can further include a far infrared ray releasing substance to release far infrared rays to accelerate blood circulation of the user.

When the dual purpose mat presents a two-side-operating embodiment, it can give by selection the automatically heating and ventilating functions by turning over the mat; the two-side-operating embodiment comprises structurally: an air vent layer provided on an upper surface; a soft lining layer provided on a lower surface; a separating layer provided between the air vent layer and the soft lining layer; a ventilative layer provided between the air vent layer and the separating layer, one side of the ventilative layer provided in neighboring with the separating layer is provided at least with a first spacing means forming a first ventilation space, and the ventilative layer is provided in corresponding to the first ventilation space with a lot of ventilative holes extending through to the other side of the mat; a fan in communication with the first ventilation space to absorb outside air in or blow out air from the first ventilation space; a heating unit provided between the separating layer and the soft lining layer; and a control unit connected with the fan and the heating unit.

When it is desired to develop the ventilating function of the dual purpose mat, the user can place the air vent layer on top, and can manipulate the control unit to activate operation of the fan, and the fan can absorb air from outside into the first ventilation space, and can blow the air out of the ventilative holes through the air vent layer, alternatively, the outside air can be absorbed into the first ventilation space and can be blown out by the fan to endue the air vent layer with the effect of ventilating and hear scattering.

When ventilating it is desired to develop the warm keeping function of the dual purpose mat, the user can place the soft lining layer on top, and can manipulate the control unit to activate operation of the heating unit, and the heating unit can increase the entire temperature of the dual purpose mat by the heat it generates to thereby provide a suitable effect of keeping out the cold for the user, alternatively, the heating unit can further include a far infrared ray releasing substance to release far infrared rays to accelerate blood circulation of the user.

In comparison with the prior art, the present invention at least has the follower advantages:
(1) The dual purpose mat of the present invention can be switched according to the demand of a user to get an effect of ventilation or heating.
(2) The dual purpose mat of the present invention can automatically provide the effect of ventilation to make the user have the effect of feeling cooler in summertime or hot environment.
(3) The dual purpose mat of the present invention can automatically provide the effect of heating to make the user have the effect of feeling warm in wintertime or cold environment.
(4) The structure of the dual purpose mat of the present invention can be designed to be soft, light, thin and portable, and can be collapsed for storing.

The present invention will be apparent after reading the detailed description of the preferred embodiment thereof in reference to the accompanying drawings.

### BRIEF DESCRIPTION OF THE DRAWINGS

FIG. 1 is an anatomic perspective view of a first embodiment of the present invention;

FIG. 2 is an anatomic perspective view of the first embodiment of the present invention after assembling;

FIG. 3 is a schematic sectional view of the first embodiment of the present invention;

FIG. 4 is a schematic sectional view of the first embodiment of the present invention showing a reverse action of the fan;

FIG. 5 is a schematic perspective view of the first embodiment of the present invention showing a rear side of a ventilative layer;

FIG. 6 is a schematic sectional view of the first embodiment of the present invention showing a state of heat emitting;

FIG. 7 is a perspective view showing the appearance of a second embodiment of the present invention;

FIG. 8 is an anatomic perspective view of a third embodiment of the present invention;

FIG. 9 is a schematic sectional view of the third embodiment of the present invention showing a state of heat emitting.

### DETAILED DESCRIPTION OF THE PREFERRED EMBODIMENT

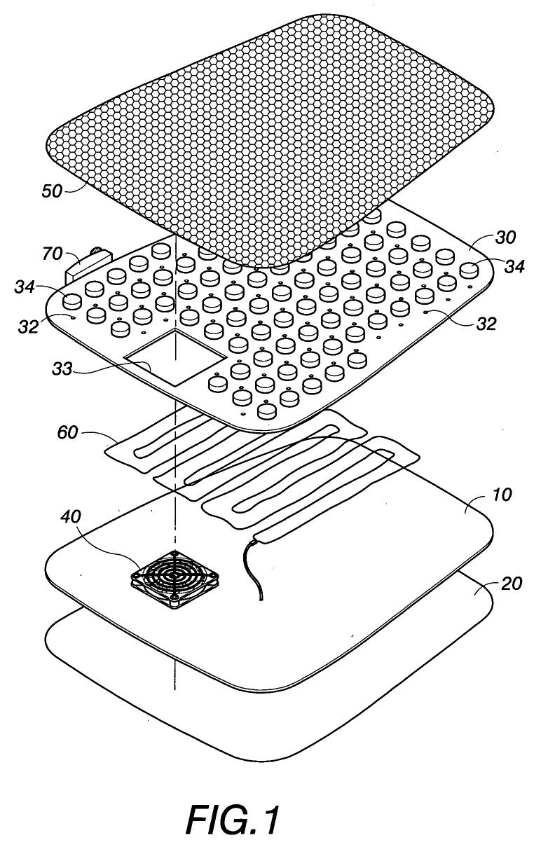

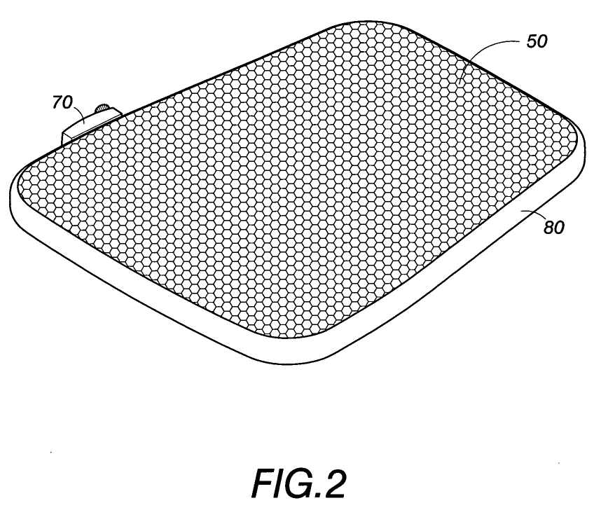

The followings present modes of practicing the dual purpose mat according to the technical means of the present invention in reference to the drawings. Referring to FIG. 1 which is an anatomic perspective view of a first embodiment of the present invention, this embodiment discloses the structure of the dual purpose mat in relation to a single-side-operating mode, the embodiment comprises: a separating layer 10, a protecting layer 20, a ventilative layer 30, a fan 40, an air vent layer 50, a heating unit 60 and a control unit 70; the appearance of the embodiment after assembling is shown in FIG. 2. When in assembling, a covering layer 80 can be provided around the dual purpose mat to protect the edges of the separating layer 10, the protecting layer 20, the ventilative layer 30 and the air vent layer 50 in order to elevate the visual effect of the entire dual purpose mat.

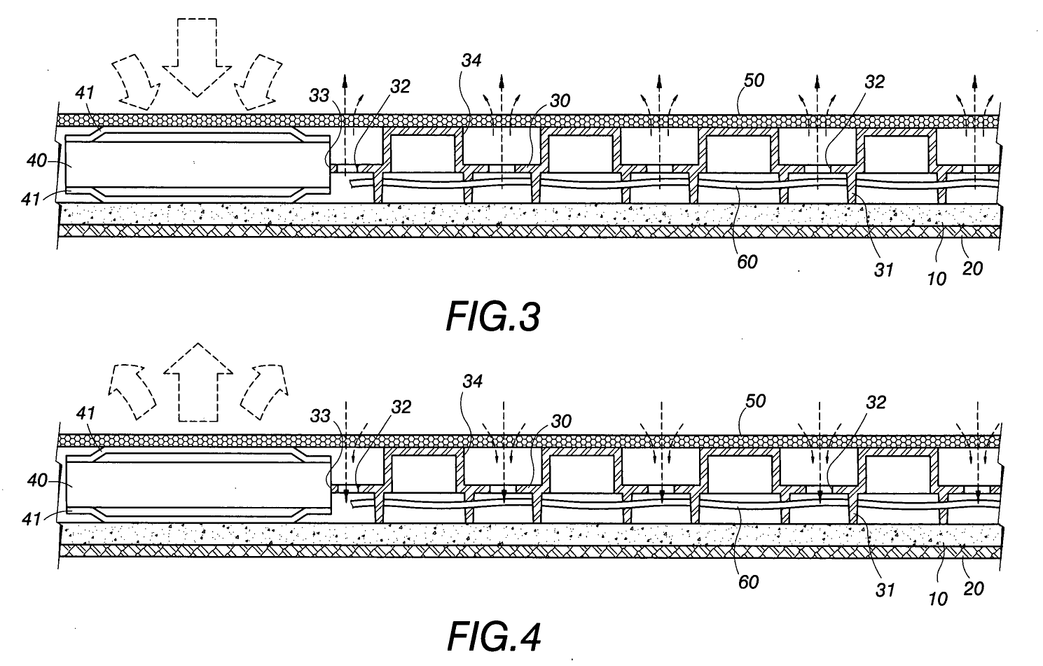

Referring to FIGS. 1 and 3, wherein FIG. 3 is a schematic sectional view of the first embodiment of the present invention, the separating layer 10 is made of foaming material in order to increase its effect of warm keeping and air insulation, while the protecting layer 20 is provided on the lower surface of the dual purpose mat and neighboring with the separating layer 10 thereabove to separate the separating layer 10 from the outside environment to thereby prevent the separating layer 10 from being damaged by piercing or scraping of an object outside.

The ventilative layer 30 neighbors with the separating layer 10 therebelow, a side of the ventilative layer 30 neighboring with the separating layer 10 is provided at least with a first spacing means 31 forming a first ventilation space (the first spacing means 31 is below the ventilative layer 30 in the drawing); the first spacing means 31 can have a lot of stubs, ribs or granules, in order that the ventilative layer 30 and the separating layer 10 can be formed therebetween the first ventilation space; alternatively, the stubs, ribs and granules can exist altogether. In the drawing, it is shown with stubs for description. And the ventilative layer 30 is provided with a lot of ventilative holes 32 extending through to the other side of the mat toward the first ventilation space.

The fan 40 is connected with the first ventilation space and the control unit 70, a way of positioning the fan 40 is disclosed in the drawing, i.e., the ventilative layer 30 is provided thereon with a fan hole 33 for placing in of the fan 40, the fan 40 can be a centrifugal fan, axial flow fan or a normal blade type fan. In the drawing, it is shown with a normal blade type fan for description.

The air vent layer 50 is provided on the upper surface of the dual purpose mat and neighboring with the ventilative layer 30 therebelow; the air vent layer 50 is in the form of a net or a piece of cloth with high air ventilating effect, this can obtain the best air ventilating effect.

When the fan 40 is operated, it can absorb outside air into the first ventilation space of the ventilative layer 30 and blow air out of the air vent layer 50 via the ventilative holes 32; or as shown in FIG. 4, by operation of the fan 40, the fan 40 can absorb outside air via the ventilative holes 32 into the first ventilation space, and then can blow air out of the air vent layer 50 to get the functions of heating and ventilating.

And more, a side of the ventilative layer 30 neighboring with the air vent layer 50 (which is above the ventilative layer 30 in the drawing) is provided at least with a second spacing means 34 forming a second ventilation space in opposition to the air vent layer 50, the second spacing means 34 can have a lot of stubs, ribs or granules, in order that the user can have better touch feeling in use, and can avoid blocking by pressing of the user during the air is absorbed in or blown out via the ventilative holes 32.

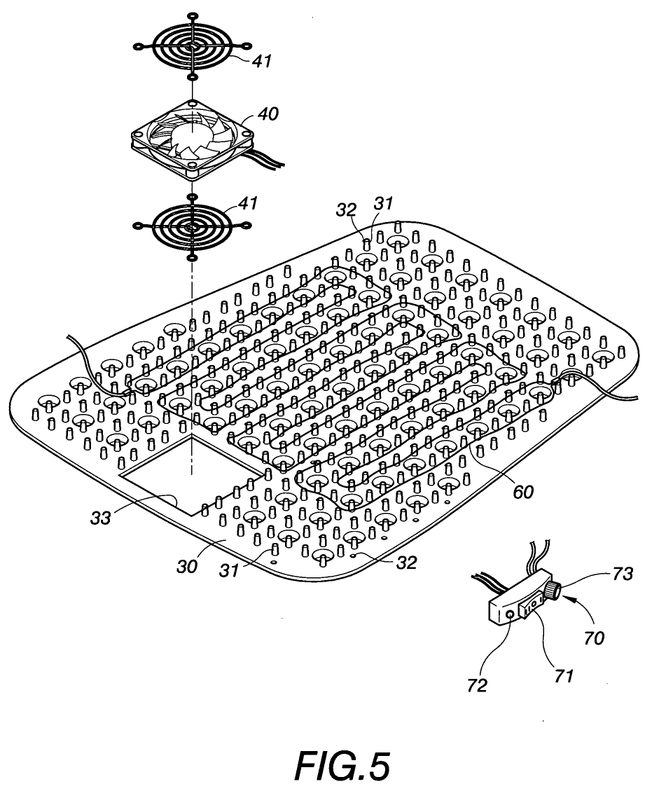

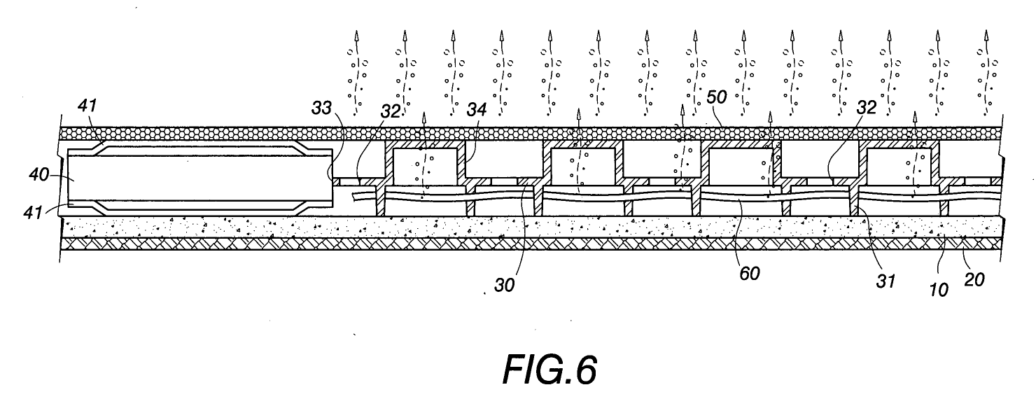

Referring to FIGS. 5 and 6, wherein FIG. 5 is a schematic perspective view of the first embodiment of the present invention showing a rear side of the ventilative layer 30, while FIG. 6 is a schematic sectional view of the first embodiment of the present invention showing a state of heat emitting; the heating unit 60 can be provided between the separating layer 10 and the air vent layer 50, for example: the heating unit 60 can be provided on the back side of the ventilative layer 30, and the heating unit 60 can be tortuously extended in the first spacing means 31 to get its effect of positioning.

When the user manipulate the control unit 70 to operate the heating unit 60, the heat generated by the heating unit 60 is used to raise the temperature of the entire dual purpose mat to provide the user with an effect of keeping out the cold; alternatively, the heating unit 60 can further include a far infrared ray releasing substance to release far infrared rays to accelerate blood circulation of the user.

And more, in order to protect the fan 40 and the blades of the fan 40, at least a protecting shield 41 is provided near the fan 40; if the fan 40 is a normal blade type fan, its intake side and outlet side can be provided each with a protecting shield 41 to assure the separating layer 10 and the air vent layer 50 neighboring with the fan 40 not to get in the fan 40 to block the blades of the fan 40 when they are pressed by outside forces; and when the fan 40 is a centrifugal fan, a single protecting shield 41 can be provided at its intake side or outlet side with a larger opening.

Moreover, when in practicing, the control unit 70 further includes a switch 71, an electric power supplying unit 72 and a rotation knob 73; the switch 71 is a three stage switching type used to switch between the fan 40 and the heating unit 60 for operation or stopping; the electric power supplying unit 72 is used to connect with an outside electric power supply such as a family electric power supply, a car electric power supply, a computer USB port etc.; the rotation knob 73 is used to control the magnitude of wind of the fan 40 and the working temperature of the heating unit 60.

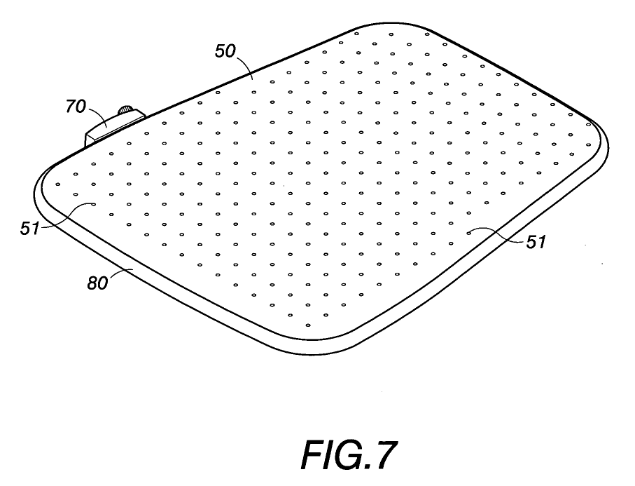

Referring to FIG. 7 which is a perspective view showing the appearance of a second embodiment of the present invention, this embodiment discloses another structure of the dual purpose mat in relation to the single-side-operating mode, difference of the second embodiment from the preceding first embodiment is resided in that: the air vent layer 50 is not in the form of a net, rather, it is made from leather with an air vent hole 51, which leather can be, for instance, genuine leather, imitation leather, plastic leather etc., for the purpose of making the dual purpose mat more beautiful.

The aforesaid first and second embodiments both can allow a user to adjust the magnitude of wind or the working temperature of the dual purpose mat, and the separating layer 10, the protecting layer 20, the ventilative layer 30, the air vent layer 50, and the heating unit 60 can be made of softer and light materials in order that the dual purpose mat can be collapsed by the user for storing.

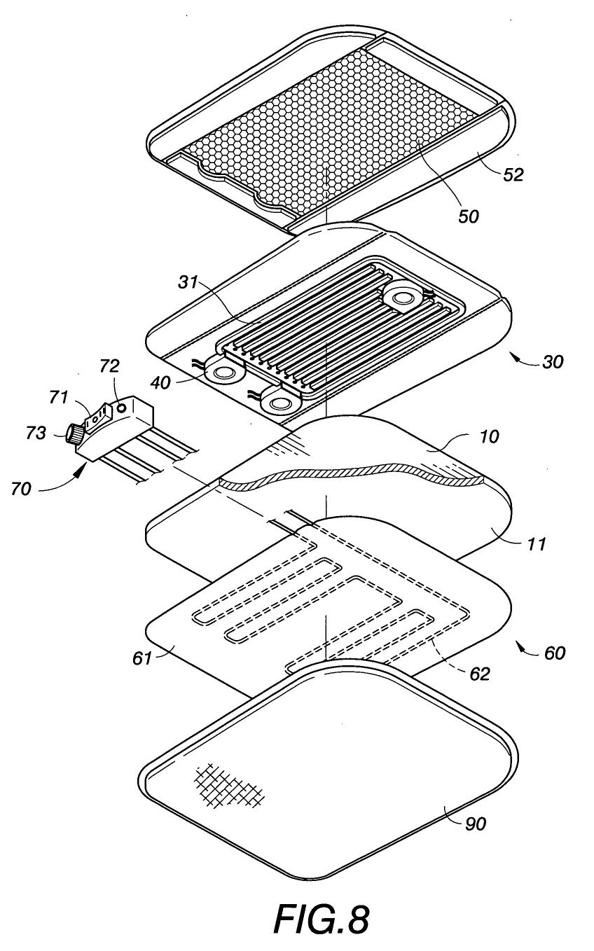

Referring to FIG. 8 which is an anatomic perspective view of a third embodiment of the present invention, this embodiment discloses the dual purpose mat presenting a two-side-operating mode, the embodiment comprises: a separating layer 10, a first buffering layer 11, a ventilative layer 30, a fan 40, an air vent layer 50, at least a second buffering layer 52, a heating unit 60, a control unit 70 and a soft lining layer 90.

The disclosure for the third embodiment is generally same by structure in principle with the first and the second embodiments disclosed above, but with the following difference: the third embodiment has the soft lining layer 90 provided on a lower surface, the heating unit 60 is provided between the separating layer 10 and the soft lining layer 90, and the first buffering layer 11 is provided beneath the separating layer 10 (between the separating layer 10 and the heating unit 60), the air vent layer 50 is provided at least with a second buffering layer 52 at a suitable area beneath the air vent layer 50 (between the air vent layer 50 and the ventilative layer 30); the first and the second buffering layers 11, 52 can be made of soft material such as puff sponge or latex in order to increase soft touch feeling and the effect of vibration absorbing of the dual purpose mat. And more, the modeling and the amount of such fan 40 used also are variant in this embodiment; in the drawing, an axial flow type fan is depicted for explanation; besides the principles of ventilation and heat scattering are generally same as that used for the first and the second embodiments disclosed above, and no further description is needed here.

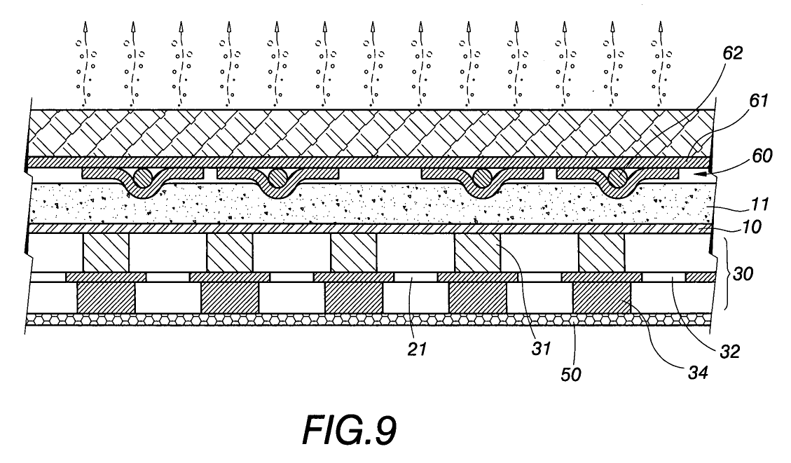

Referring to FIGS. 8 and 9, in which FIG. 9 is a schematic sectional view of the third embodiment of the present invention showing a state of heat emitting; the largest difference of the embodiment from the preceding first and second embodiments is resided in that: when it is desired to develop the warm keeping function of the dual purpose mat, the dual purpose mat shall be turned upside down to make the soft lining layer 90 face down and the air vent layer 50 face up, the soft lining layer 90 can be made from normal cloth such as normal cotton cloth, down cloth etc. or leather to increase the effect of warm keeping.

Particularly, the heating unit 60 in this embodiment is located between the separating layer 10 and the soft lining layer 90, hence in practicing, the heating unit 60 can be a carbon fiber heat emitting wire heating according to the principle of electric-resistance heating, a printed heating sheet, some other heating member or a far infrared ray releasing substance, it is directly or indirectly fixed between the separating layer 10 and the soft lining layer 90; this embodiment has a heating wire 62 tortuously extending on a piece of cloth 61; when the heating wire 62 emits heat, it emits heat uniformly on the cloth 61, the rising temperature is transmitted to the surfaces of the soft lining layer 90.

However, the above specification and drawings are only for illustrating the preferred embodiments of the present invention, for instance: the different locations, shapes and structures of the heating unit 60 in the drawings, and not for giving any limitation to the scope of the present invention. It will be apparent to those skilled in this art that various equivalent modifications or changes without departing from the spirit and scope of this invention shall fall within the scope of the appended claims.

1. A dual purpose mat comprising:
a separating layer;
a ventilative layer neighboring with said separating layer, a side of said ventilative layer neighboring with said separating layer being provided at least with a first spacing means forming a first ventilation space, said ventilative layer being provided in corresponding to said first ventilation space with a lot of ventilative holes extending through to other side of said dual purpose mat;
an air vent layer provided neighboring with said ventilative layer and provided on an upper surface of said dual purpose mat;
a fan in communication with said first ventilation space;
a heating unit provided between said separating layer and said air vent layer; and
a control unit connected with said fan and said heating unit.

2. The dual purpose mat as in claim 1, wherein: said first spacing means has a lot of stubs, ribs or granules.

3. The dual purpose mat as in claim 1, wherein: a side of said ventilative layer neighboring with said air vent layer is provided at least with a second spacing means forming a second ventilation space in opposition to said air vent layer.

4. The dual purpose mat as in claim 3, wherein: said second spacing means has a lot of stubs, ribs or granules.

5. The dual purpose mat as in claim 1, wherein: said air vent layer is in a form of a net, it is made from leather with an air vent hole.

6. The dual purpose mat as in claim 1, wherein: said dual purpose mat is provided on a lower surface thereof with a protecting layer which neighbors with said separating layer, said separating layer is made of foaming material.

7. The dual purpose mat as in claim 1, wherein: said heating unit is a carbon fiber heat emitting wire or a far infrared ray releasing substance.

8. The dual purpose mat as in claim 1, wherein: said heating unit is located between said ventilative layer and said separating layer.

9. The dual purpose mat as in claim 1, wherein: said dual purpose mat is provided at least with a protecting shield near said fan.

10. The dual purpose mat as in claim 1, wherein: said control unit further includes a switch and an electric power supplying unit.

11. The dual purpose mat as in claim 10, wherein: said electric power supplying unit is a battery, an electric power line or an electric power connector.

12. The dual purpose mat as in claim 1, wherein: said control unit further includes a rotation knob used to control magnitude of wind and working temperature.

13. A dual purpose mat comprising:
an air vent layer provided on an upper surface of said dual purpose mat;
a soft lining layer provided on a lower surface of said dual purpose mat;
a separating layer provided between said air vent layer and said soft lining layer;
a ventilative layer provided between said air vent layer and said separating layer, one side of said ventilative layer provided in neighboring with said separating layer being provided at least with a first spacing means forming a first ventilation space, and said ventilative layer being provided in corresponding to said first ventilation space with a lot of ventilative holes extending through to said other side of said dual purpose mat;
a fan in communication with said first ventilation space;
a heating unit provided between said separating layer and said soft lining layer; and
a control unit connected with said fan and said heating unit.

14. The dual purpose mat as in claim 13, wherein: said heating unit is a printed heating sheet, a carbon fiber heat emitting wire tortuously extending on a piece of cloth, or a far infrared ray releasing substance.

15. The dual purpose mat as in claim 13, wherein: a first buffering layer is provided between said separating layer and said heating unit.

16. The dual purpose mat as in claim 13, wherein: said first spacing means has a lot of stubs, ribs or granules.

17. The dual purpose mat as in claim 13, wherein: at least a second buffering layer is provided between said air vent layer and said ventilative layer.

18. The dual purpose mat as in claim 13, wherein: said control unit further includes a switch, an electric power supplying unit and a rotation knob used to control magnitude of wind and working temperature.

19. The dual purpose mat as in claim 13, wherein: a side of said ventilative layer neighboring with said air vent layer is provided at least with a second spacing means forming a second ventilation space in opposition to said air vent layer.

20. The dual purpose mat as in claim 13, wherein: said second spacing means has a lot of stubs, ribs or granules.
